(19) United States
(12) Patent Application Publication
(10) Pub. No.: US 2008/0121500 A1
(43) Pub. Date: May 29, 2008

(54) Vehicular lever switch apparatus

(75) Inventors: Hideki Matsumura, Aichi (JP); Isao Maeda, Aichi (JP); Hiroshi Kusama, Aichi (JP); Norikazu Yoshida, Aichi (JP); Fumitaka Hayase, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho

(21) Appl. No.: 11/984,626

(22) Filed: Nov. 20, 2007

(30) Foreign Application Priority Data
Nov. 24, 2006 (JP) 2006-317109
Nov. 24, 2006 (JP) 2006-317110

(51) Int. Cl. H01H 21/04

(52) U.S. Cl. 200/61.54

(57) ABSTRACT

A slider operated to slide by a lever for light is constructed by an arrangement capable of being integrated by inserting a portion thereof to a cylindrical portion of a slide guide portion provided at an insulator. Thereby, an integrating performance can be promoted in comparison with that of a structure of squeezing the slider by 2 parts. Further, a clearance in a height direction of the slider can be controlled by one part of the insulator, and therefore, a variation thereof can be reduced in comparison with that of the case of controlling the clearance by 2 parts.

### BACKGROUND OF THE INVENTION

The present invention relates to a vehicular lever switch apparatus having an arrangement of switching a state of a switch element by sliding to move a slider based on a pivoting operation of a lever around an axis.

In a related art, there is a vehicular lever switch apparatus unitized with, for example, a turn signal switch, a dimmer passing switch, and a light switch. FIG. 9 through FIG. 13 show an example of a related art of a switch apparatus of this kind. A unit case 1 of the switch apparatus is constituted by an insulator 2 provided with a terminal or the like, a middle case 3 integrated to an upper portion of the insulator 2, and an upper cover 4 integrated to an upper portion of the middle case 3 to cover an upper surface thereof. The upper cover 4 constitutes a ceiling portion of the unit case 1.

Inside of the unit case 1 is arranged with a bracket 5 for turning. The bracket 5 is attached to the unit case 1 pivotably in an arrow mark A1 direction of FIG. 9 centering on a shaft portion 5a. An inner surface of the middle case 3 opposed to a front end portion of the bracket 5 is provided with a recessed and projected portion for a node 6 for turning, the bracket 5 is provided with a node piece 7a and a node spring 7b, and the node piece 7a urged by the node spring 7b is brought into contact with the recessed and projected portion for a node 6, A node mechanism 8 for turning is constituted by the recessed and projected portion for a node 6, the node piece 7a, and the node spring 7b. A lower portion on a side of the front end portion of the bracket 5 is provided with a movable contact 9a, an upper surface of the insulator 2 is provided with a fixed contact 9b with and from which the movable contact 9a is brought into contact and detached, and a turn switch 10 is constituted by the movable contact 9a and the fixed contact 9b.

One end portion of an operating lever 11 is inserted to inside of the bracket 5, and the one end portion is attached to the bracket 5 by way of a shaft portion 11a. The operating lever 11 is made to be pivotable in an arrow mark A2 direction in FIG. 10 by constituting a fulcrum by the shaft portion 11a. Other end portion (right end portion of FIG. 9) of the operating lever 11 is projected from the unit case 1 and the bracket 5 to outer side. A portion of an inner surface of the bracket 5 opposed to a front end portion of the one end portion of the operating lever 11 is provided with a recessed and projected portion for a node 12 for dimmer passing, the operating lever 11 is provided with a node piece 13a and a node spring 13b, and the node piece 13a urged by the node spring 13b is brought into contact with the recessed and projected portion for a node 12. A node mechanism 14 for dimmer passing is constituted by the recessed and projected portion for a node 12, the node piece 13a, and the node spring 13b.

Substantially a center portion of an upper surface of the insulator is arranged with a slider 15 for dimmer passing. The slider 15 is restricted from being moved to an upper side by guide portions 16 (refer to FIG. 13) provided at two left and right guide portions of a lower portion of the middle case 3, a guide projected portion 15a formed at an upper surface of the slider 15 is inserted into a guide groove (not illustrated) formed at the guide portion 16, and the slider 15 is provided to be able to slide to move in an arrow mark A3 direction (refer to FIG. 10) along the guide groove.

The slider 15 includes a plurality of cam portions 15b at a lower surface thereof, and includes a pair of walls 15d forming a groove portion 15c constituting a circular arc shape at an upper surface thereof. An arm holder 17 is attached to the front end portion of the operating lever 11, and a projected portion 17a of the arm holder 17 is inserted to the groove portion 15c.

The insulator 2 is provided with a plurality of pieces of fixed contacts 18 to be disposed at a vicinity of a lower side of the slider 15. A lower surface of the insulator 2 is arranged with a plurality of movable pieces 19 made by leaf springs. The movable piece 19 is fixed to the lower surface of the insulator 2 at a base end portion thereof, includes a contact portion 19a brought into contact with and detached from the fixed contact 18 at a front end portion thereof and includes a push rod 19b, and is brought into a state in which an upper end portion of the push rod 19b is made to be projected to an upper surface side of the insulator by penetrating the insulator 2. A dimmer passing switch 20 is constituted by the fixed contact 18 and the movable piece 19.

Here, when the operating lever 11 is operated to pivot in the arrow mark A1 direction centering on the Shaft portion 5a of the bracket 5, the operating lever 11 and the bracket 5 are integrally pivoted in the arrow mark A1 direction and a state of the turn switch 10 is switched in accordance with pivoting the bracket 5. At this occasion, although also the projected portion 17a of the arm holder 17 is pivoted in the same direction, the projected portion 17a is moved along the groove portion 15c constituting the circular arc shape of the slider 15, and therefore, the slider 15 is not moved.

Further, when the operating lever 11 is operated to pivot in the arrow mark A2 direction relative to the bracket 5, the operating lever 11 is pivoted in the arrow mark A2 direction by constituting a fulcrum by the shaft portion 11a by leaving the bracket 5. Then, the slider 15 is slid to move in the arrow mark A3 direction by way of the arm holder 17, a front end portion of the movable piece 19 is displaced in an up and down direction by way of the push rod 19b by the cam portion 15b of the slider 15, and the state of the dimmer passing switch 20 is switched by bringing and detaching the contact portion 19a into contact with and from the fixed contact 18.

A lever 21 for light extended in an axial direction is inserted to an inner portion of the operating lever 11 pivotably in a direction around an axis (arrow mark A4 direction). The lever 21 for light is operated to pivot by a knob 22 for light attached to a front end portion of the operating lever 11. An end portion of the lever 21 for light is provided with an operating projected portion 21a. An upper surface of the insulator 2 is arranged with a slider 23 for light to be disposed on a lower side of the operating projected portion 21a. The slider 23 is arranged to be able to slide to move in an arrow mark A5 direction along a slider guide portion 24 provided at the insulator 2, and is restricted from moving in an upper direction by a restricting portion 3a (refer to FIG. 12) in an eaves-Like shape provided at a lower portion of the middle case 3.

Further, the slider 23 includes a cam portion 23a at a lower surface thereof, and includes a pair of walls 23c forming a groove portion 23b at an upper portion thereof, and the operating projected portion 21a is inserted to the groove portion 23b. A lower surface side of the insulator 2 is provided with a light switch 25 having an arrangement similar to that of the dimmer passing switch 20 to be disposed on a lower side of the slider 23. The light switch 25 is constituted by a fixed contact 26 provided at a lower surface of the insulator 2 and a movable piece 27 including a contact portion 27a and a push rod 27b. A node piece 28a and a node spring 28b constituting a node mechanism 28 for light are arranged between the operating lever 11 and the knob 22 for light.

Here, when the lever 21 for light is operated to pivot in the arrow mark A4 direction by the knob 22 for light, the slider 23 is slid to move in the arrow mark A5 direction by way of the operating projected portion 21a, and a state of the light switch 25 is switched in accordance therewith.

A lower side of the insulator 2 is mounted with a lower cover 29. Further, an upper surface of the bracket 5 is provided with a cancel mechanism 30 including a ratchet 30a and a back plate 30b.

Further, as a vehicular lever switch apparatus, there is, for example, JP-A-2006-256491 although the reference is not directly related to the problem to be solved of the invention.

In the related art arrangement, with regard to integration of the slider 23 for light, there is adopted a structure for placing the slider 23 at the upper surface of the slider guide portion 24 of the insulator 2, integrating the middle case 3 from thereabove, and squeezing the slider 23 from a height direction by the insular 2 and the restricting portion 3a of the middle case 3. In other words, the slider 23 is restricted in the height direction by two parts of the insulator 2 and the middle case 3, and therefore, there poses a problem that a variation is liable to be brought about in a clearance in the height direction by tolerances of the two parts, an operation of the light switch 25 constituting a switch element is liable to be instabilized. Further, the slider 23 needs to be squeezed by the two parts of the insulator 2 and the middle case 3, and therefore, there also poses a problem that an integrating performance is deteriorated.

According to the related art constitution, the slider 15 for dimmer passing is guided to move in the arrow mark A3 direction by the guide portion 16 provided at the lower portion of the middle case 3, and the slider 15 is restricted from moving in the upper direction. Therefore, it is necessary to constitute the unit case 1 by 3 parts of the insulator 2, the middle case 3, and the upper cover 4. Therefore, there poses a problem that a number of parts is large.

### SUMMARY OF THE INVENTION

The invention has been carried out in view of the above-described situation and it is an object thereof to provide a vehicular lever switch apparatus capable of reducing a variation in a clearance in a height direction of a slider and capable of promoting an integrating performance.

An further object of the present invention is to provide a vehicular lever switch apparatus capable of reducing a number of parts.

In order to achieve the above-described object, a vehicular lever switch apparatus of the invention comprises:

an insulator;

a case integrated to an upper portion of the insulator;

a slider slidably arranged at an upper surface of the insulator;

a slider guide portion including a cylindrical portion provided at the insulator for restricting the slider from moving in an upper direction and slidably guiding the slider;

a lever extended in an axial direction and provided to be able to be operated to pivot in a direction around the axial direction for sliding the slider in accordance with a pivoting operation of the lever around the axial direction; and

a switch element a state of which is switched in accordance with sliding movement of the slider.

According to the above-described means, the slider can be integrated by being inserted to the cylindrical portion of the slide guide portion provided at the insulator, and therefore, an integrating performance can be promoted in comparison with a structure of squeezing a slider by 2 parts. Further, a clearance in a height direction of the slider can be controlled by one part of the insulator, and therefore, a variation thereof can be reduced in comparison of the case of controlling the clearance by 2 parts.

Further, in order to achieve the above-described object, a vehicular lever switch apparatus of the invention comprises:

an insulator;

a case that includes a ceiling portion integrated to an upper portion of the insulator and constitutes a unit case in cooperation with the insulator;

an operating lever that includes an end portion inserted to inside of the unit case, a shaft portion which pivotably attached to the unit case as a fulcrum and the other end portion which is projected from the unit case to an outer side and is pivotably manipulated by a user;

a guide portion provided at an upper surface of the insulator;

a slider arranged at the upper surface of the insulator slidably along the guide portion and slid in accordance with pivoting movement of the one end portion of the operating lever based on a pivoting manipulation of the operating lever;

a restricting portion provided at the case for restricting the slider from moving in an upper direction; and

a switch element a state of which is switched in accordance with sliding to move the slider.

According to the invention, by constructing a constitution in which the insulator is provided with the guide portion for guiding to move the slider sliding to move in accordance with an operation of the operating lever and the case is provided with the restricting portion for restricting the slider from moving to the upper side, a function of the guide portion provided at the middle case of the background art is distributed to the insulator and the case. Thereby, the unit case can be constituted by the insulator and the case having the ceiling portion, and the middle case which has been needed in the background art can be abolished. Therefore, the number of parts can be reduced.

### BRIEF DESCRIPTION OF THE DRAWINGS

FIG. 1 is a disassembled perspective view showing an embodiment of the invention.

FIG. 2 is a plane view.

FIG. 3 is a vertical sectional front view taken along a line X1-X1 of FIG. 2.

FIG. 4 is a vertical sectional right side view taken along a line X2-X2 of FIG. 2.

FIG. 5 is a plane view in a state of integrating 2 pieces of sliders to an insulator.

FIG. 6 is a vertical sectional right side view taken along a line X3-X3 of FIG. 5.

FIG. 7 is a perspective view of the insulator viewed from a direction different from that of FIG. 1.

FIG. 8 is a vertical sectional right side view omitting to show a portion by cutting FIG. 2 by a portion in correspondence with a line X2-X2.

FIG. 9 is a view in correspondence with FIG. 1 showing a related art arrangement.

FIG. 10 is a view in correspondence with FIG. 3.

FIG. 11 is a view in correspondence with FIG. 5.

FIG. 12 is a vertical sectional right side view taken along a line X4-X4 of FIG. 10.

FIG. 13 is a view in correspondence with FIG. 8.

### DETAILED DESCRIPTION OF PREFERRED EMBODIMENTS

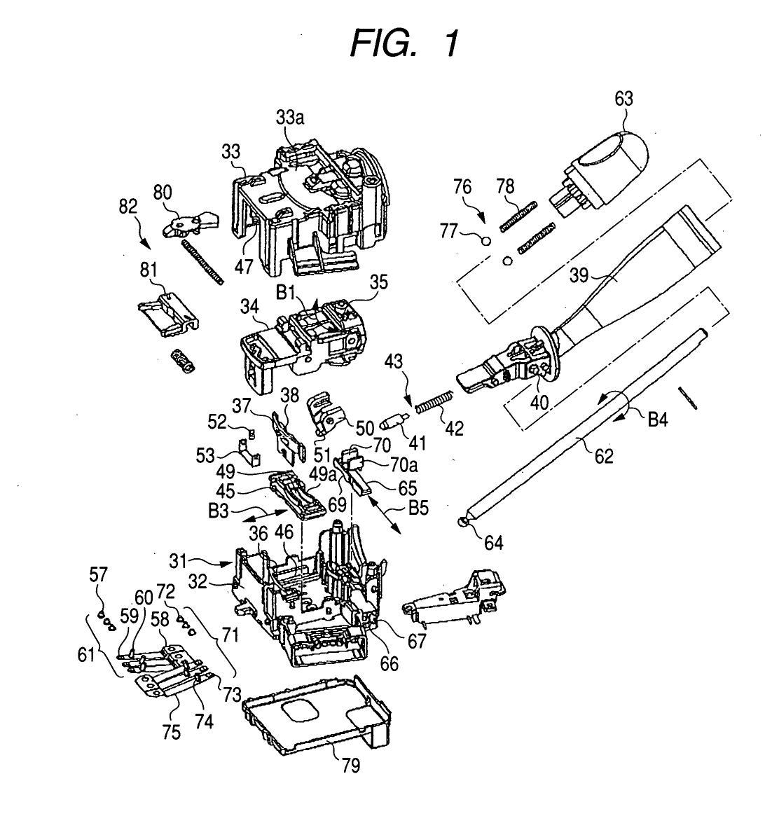

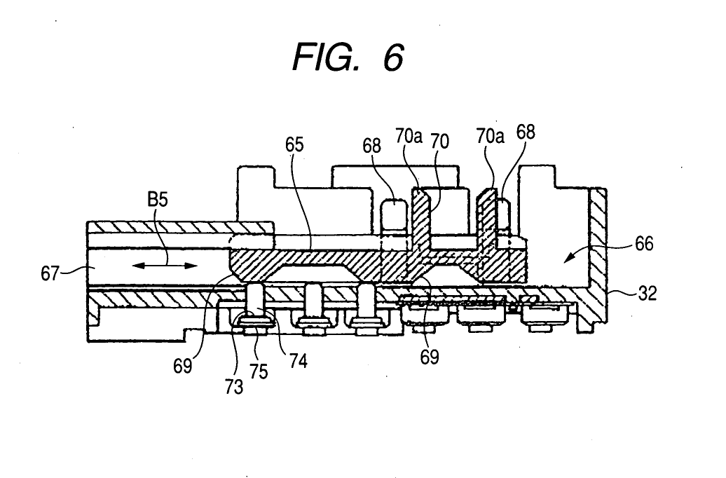

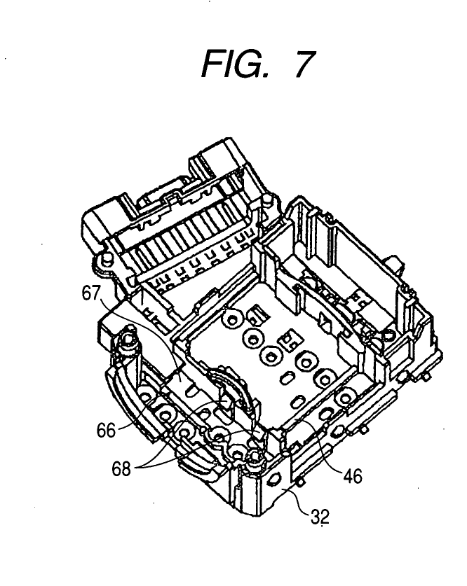

An embodiment of the invention will be explained in reference to FIG. 1 through FIG. 7 as follows.

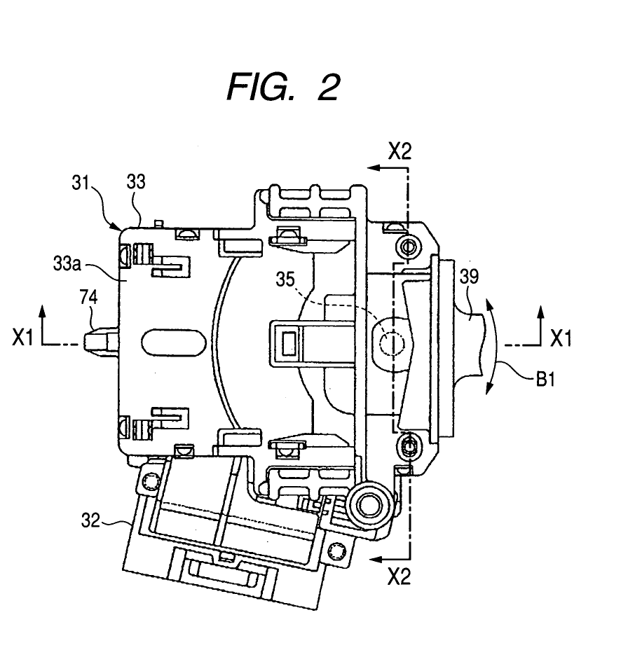

A unit case 31 is constituted by an insulator 32, and a case 33 having a ceiling portion 33a and integrated to an upper portion of the insulator 32. Inside of the unit case 31 is arranged with a bracket 34 for turning. The bracket 34 is attached pivotably in an arrow mark B1 direction of FIG. 1 and FIG. 2 centering on a shaft portion 35 of the unit case 31. An upper portion of the insulator 32 is provided with a detent plate attaching portion 36 to be disposed at an inner portion of the bracket 34, and the detent plate attaching portion 36 is attached with a detent plate 37 in a fixed state. The detent plate 37 is provided with a recessed and projected portion for a node 38 for turning and dimmer passing.

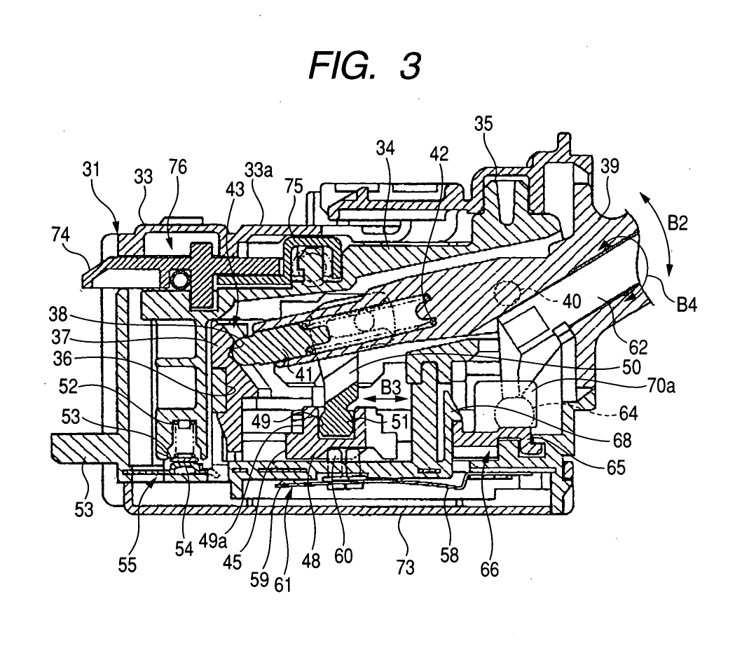

One end portion of an operating lever 39 is inserted to inside of the bracket 34, and the one end portion is attached to the bracket 34 by way of a shaft portion 40. The operating lever 39 is made to be pivotable in an arrow mark B2 direction in FIG. 3 by constituting a fulcrum by the shaft portion 40. other end portion (right end portion of FIG. 1) of the operating lever 39 is projected from the unit case 31 and the bracket 34 to an outer side. A front end portion of the one end portion of the bracket 34 is provided with a node piece 41 and a node spring 42 for urging the node piece 41, and a front end portion of the node piece 41 is brought into contact with a recessed and projected portion for a node 38 of the detent plate 37. Here, a node mechanism 43 is constituted by the recessed and projected portion for a node 38 of the detent plate 37, the node piece 41, and the node spring 42.

In this case, when the operating lever 39 is operated to pivot in the arrow mark B1 direction, the operating lever 39 and the bracket 34 are integrally pivoted in the arrow mark B1 direction centering on the shaft portion 35. At this occasion, a node feeling is provided by the node mechanism 43. Further, when the operating lever 39 is operated to pivot in the arrow mark B2 direction, the operating lever 39 is pivoted in the arrow mark B2 direction by constituting the fulcrum by the shaft portion 40 by leaving the bracket 34. Also in this case, the node feeling is provided by the node mechanism 43.

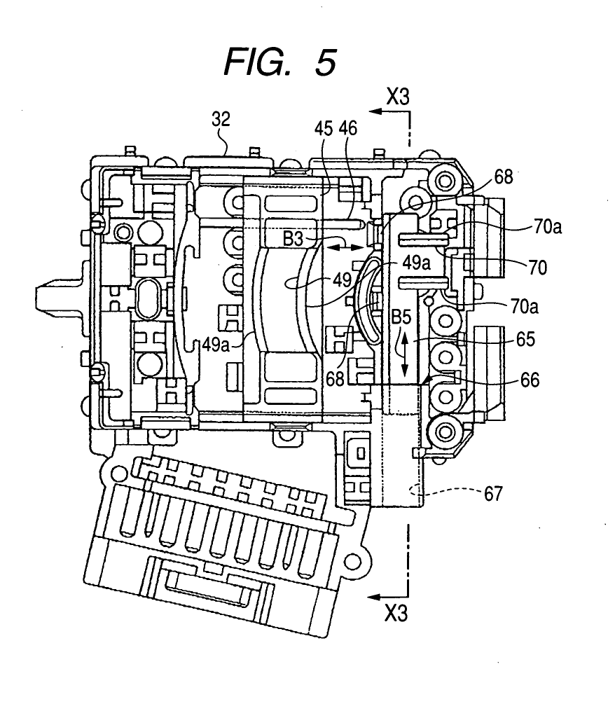

A slider 45 for dimmer passing is arranged at substantially a center portion of an upper surface of the insulator 32. A guide projected portion 46 extended in a left and right direction of FIG. 1 is provided to be proximate to one side portion of the upper surface of the insulator 32. The slider 45 is provided to be able to be slid to move in an arrow mark B3 direction of FIG. 1, FIG. 3, FIG. 5 along the guide projected portion 46. The slider 45 includes a plurality of pieces of cam portions 48 at a lower surface thereof, and includes a pair of walls 49a forming a groove portion 49 constituting a circular arc shape an upper surface side of which is opened at an upper portion thereof. A front end portion of one end portion of the operating lever 39 is attached with an arm holder 50, and a projected portion 51 of the arm holder 50 is inserted to the groove portion 49.

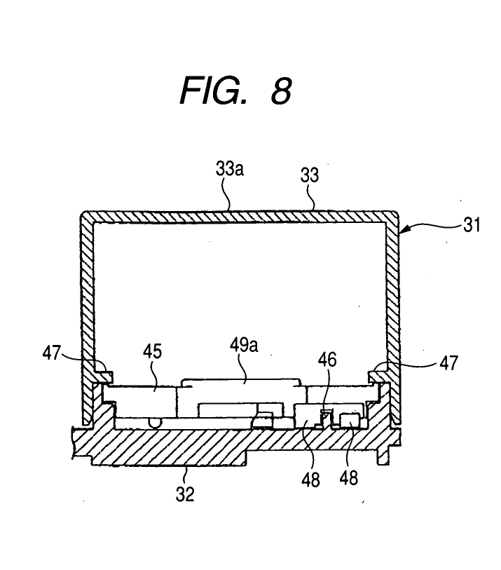

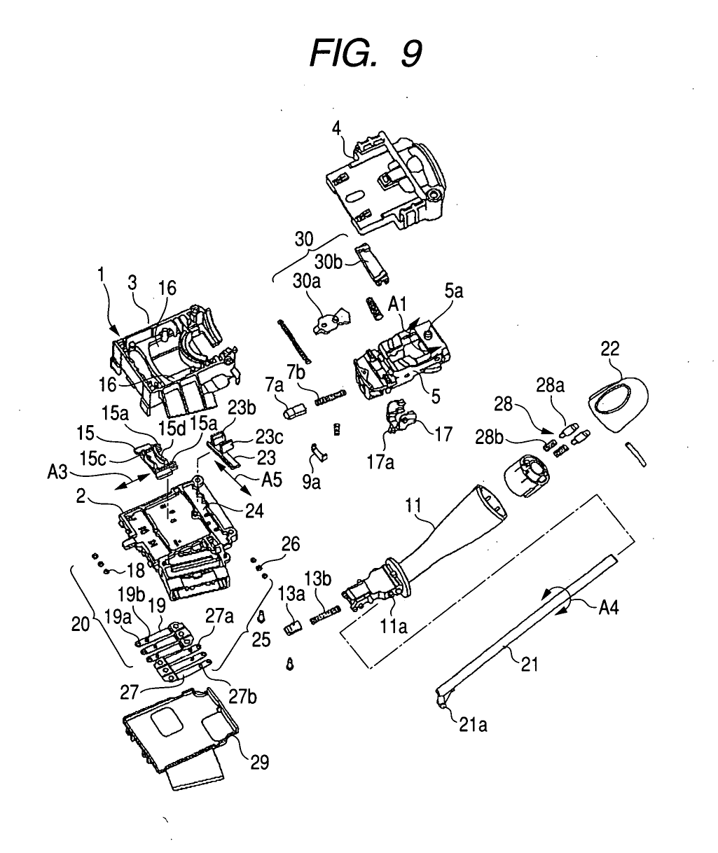

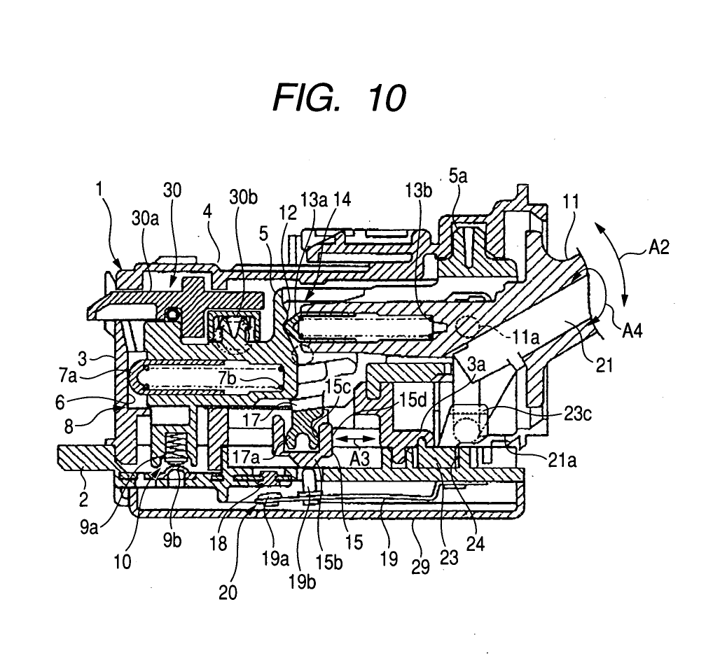

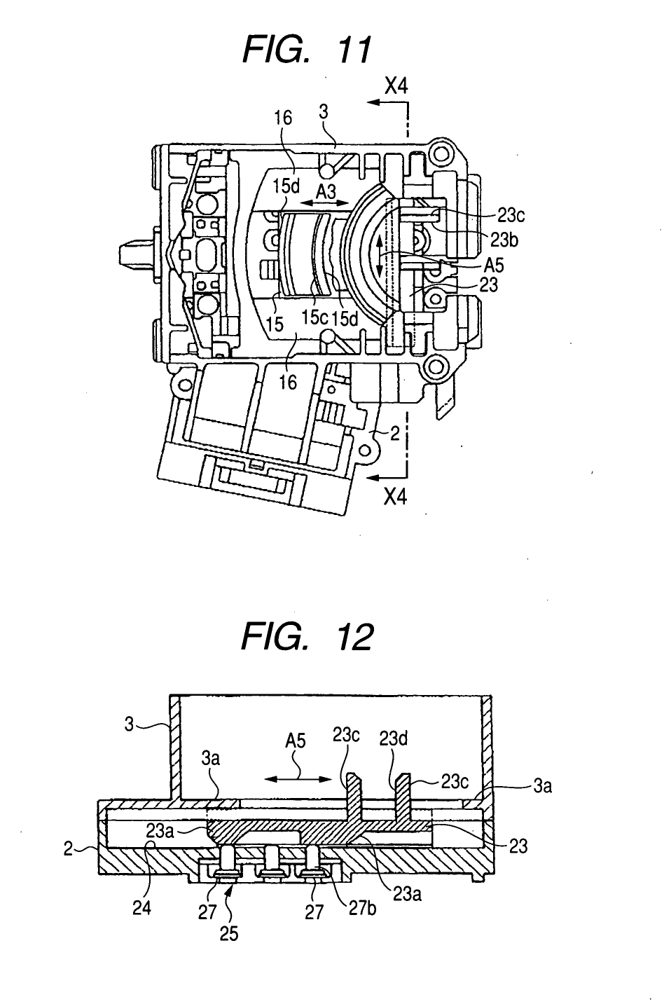

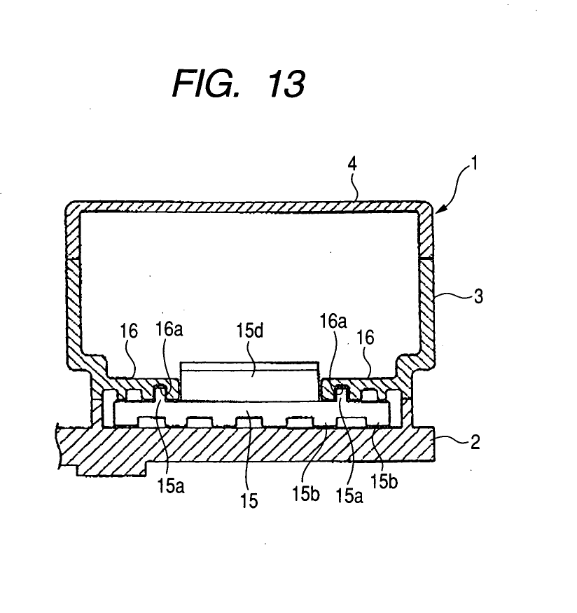

The slider for dimmer passing (in correspondence with the slider of the invention) 45 is arranged substantially at a center portion of an upper surface of the insulator 32. The guide projected portion (in correspondence with the guide portion) 46 extended in a left and right direction of FIG. 1 is provided proximate to one side portion of an upper surface of the insulator 32. The slider 45 is provided to be able to slide to move in an arrow mark B3 direction of FIG. 1 and FIG. 3 along the guide projected portion 46 and is restricted from moving to the upper side by restricting portions 47 (refer to FIG. 8) in an eaves-like shape provided at both side portions of a lower portion of the case 33. The slider includes a plurality of pieces of cam portions 48 at a lower surface thereof and includes a pair of walls 49a forming a groove portion 49 constituting a circular arc shape an upper surface side of which is opened at an upper portion thereof. A front end portion of the one end portion of the operating lever 39 is attached with an arm holder 50 and a projected portion 51 of the arm holder 50 is inserted into the groove portion 49.

A lower portion on a side of the front end portion of the bracket 34 is provided with a movable contact 53 urged to a lower side by a spring 52, an upper surface of the insulator 32 is provided with a fixed contact 54 with and from which the movable contact 53 is brought into contact and detached, a turn switch 55 is constituted by the movable contact 53 and the fixed contact 54.

The insulator 32 is provided with a plurality of pieces of fixed contacts 57 to be disposed at a vicinity of a lower side of the slider 45. A lower surface of the insulator 32 is arranged with a plurality of movable pieces 58 made by leaf springs. The movable piece 58 is fixed to a lower surface of the insulator 32 at a base end portion thereof, includes a contact portion 59 which is brought into contact with and detached from the fixed contact 57 at a front end portion thereof, and includes a push rod 60 and is brought into a state in which an upper end portion of the push rod 60 is made to be able to be projected to an upper surface side of the insulator 32 by penetrating a hole formed at the insulator 32. A dimmer passing switch 61 is constituted by the fixed contact 57 and the movable piece 58.

Here, when the operating lever 39 is operated to pivot in the arrow mark B1 direction centering on the shaft portion 35 of the bracket 34, the operating lever 39 and the bracket 34 are integrally pivoted in the arrow mark B1 direction, and a state of the turn switch 55 is switched in accordance with pivoting the bracket 34. At this occasion, although also the projected portion 51 of the arm holder 50 is pivoted in the same direction, the projected portion 51 is moved along the groove portion 49 constituting the circular arc shape of the slider 45, and therefore, the slider 45 is not moved.

Further, when the operating lever 39 is operated to pivot in the arrow mark B2 direction relative to the bracket 34, the slider 45 is slid to move in the arrow mark B3 direction by way of the arm holder 50, a front end portion of the movable piece 19 is displaced in an up and down direction by way of the push rod 60 by the cam portion 48 of the slider 45, and a state of the dimmer passing switch 61 is switched by bringing and detaching the contact portion 59 into contact with and from the fixed contact 57.

A lever 62 for light (in correspondence with lever of the invention) extended in an axial direction is inserted to an inner portion of the operating lever 39 pivotably in a direction around an axis (arrow mark B4 direction). The lever 62 for light is operated to pivot by a knob 63 for light attached to a front end portion of the operating lever 39. An end portion of the lever 62 for light is provided with an operating projected portion 64. An upper surface of the insulator 32 is arranged with a slider 65 for light (in correspondence with a slider of the invention) to be disposed on a lower side of the operating projected portion 64.

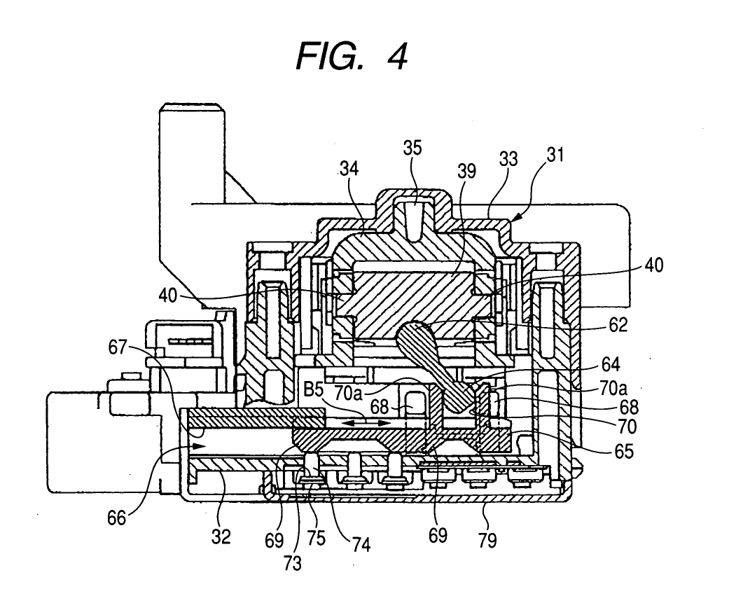

Also as shown in FIG. 4 through FIG. 7, the insulator 32 is provided with a slider guide portion 66 for guiding to slide to move the slider 65. The slider guide portion 66 is provided with a cylindrical portion 67 extended in an arrow mark B5 direction substantially orthogonal to the arrow mark B3 direction constituting a direction of moving the slider 45, and provided with 2 pieces of claw portions 68 for preventing detachment. The cylindrical portion 67 is formed by a slide die in molding. Further, the slider 65 is restricted from moving to an upper side and guided to move to slide in the arrow mark B5 direction by inserting a portion thereof to the cylindrical portion 67. Further, the slider 65 is restricted from moving to the upper side also by the claw portion 68.

The slider 65 includes a plurality of cam portions 69 at a lower surface thereof, and includes a pair of walls 70a forming a groove portion 70 at an upper portion thereof, and the groove portion 70 is inserted with the operating projected portion 64 and the lever 62 for light. A lower surface side of the insulator 32 is provided with a light switch (in correspondence with switch element of the invention) 71 similar to the dimmer passing switch 61. The light switch 71 is constituted by a fixed contact 72 provided at a lower surface of the insulator 32, and a movable piece 75 including a contact portion 73 and a push rod 74, and is brought into a state in which an upper end portion of the push rod 74 is made to be able to be projected to an upper surface side of the insulator 32 by penetrating a hole formed at the insulator 32. A node ball 77 and a node spring 78 constituting a node mechanism 76 are arranged between the operating lever 39 and the knob 63 for light.

Here, when the lever 62 for light is operated to pivot in the arrow mark B4 direction by the knob 63 for light, the slider 65 is slid to move in the arrow mark B5 direction by way of the operating projected portion 64 and a state of the light switch 71 is switched in accordance therewith.

A lower cover 79 is mounted to a lower side of the insulator 32. Further, an upper surface of the bracket 34 is provided with a cancel mechanism 82 having a ratchet 80, a back plate 81 and the like. The cancel mechanism 82 is for automatically returning the operating lever 39 and the bracket 34 to neutral positions based on rotating a cancel cam, not illustrated, in accordance with rotating a steering wheel, not illustrated, in a state in which the operating lever 39 and the bracket 34 are disposed at a left turn indicating position or a right turn indicating position in turning operation.

In the above-described embodiment, the following operation and effect can be achieved. That is, the slider 65 for light is integrated by being inserted to the cylindrical portion 67 of the slider guide portion 66 provided at the insulator 32, and therefore, an integrating performance can be promoted in comparison with that of a structure squeezing the slider by two parts. Further, a clearance in a height direction of the slider 65 can be controlled by one part of the insulator 32, and therefore, in comparison with a case of controlling the clearance by 2 parts, a variation can be reduced. Further, it is not necessary to hold the slider 65 by the case 33, and therefore, the middle case which has been needed in the related art can be dispensed with, the unit case 31 can be constituted by 2 parts of the insulator 32 and the case 33 integrated to an upper portion thereof.

The slider 65 is arranged to be able to slide to move in an arrow mark B5 direction along the slider guide portion 66 provided at the insulator 32. The slider 65 includes a cam portion 67 at a lower surface thereof and includes a pair of walls 70a forming a groove portion 70 at an upper portion thereof and the operating projected portion 64 is inserted into the groove portion 70. A lower surface side of the insulator 32 is provided with a light switch 71 having a constitution similar to that of the dimmer passing switch 61 to be disposed on a lower side of the slider 65. A node ball 77 and a node spring 78 constituting a node mechanism 76 for light are arranged between the operating lever 39 and the knob 63 for light.

Here, when the lever 62 for light is operated to pivot in the arrow mark B4 direction by the knob 63 for light, the slider 65 is slid to move in the arrow mark B5 direction by way of the operating projected portion 64 and a state of the light switch 71 is switched in accordance therewith.

A lower side of the insulator 32 is mounted with a lower cover 79. Further, an upper surface of the bracket 34 is provided with a cancel mechanism 82 including a ratchet 80, a back plate 81 and the like. The cancel mechanism 82 is for automatically returning the operating lever 39 and the bracket 34 to neutral positions based on rotating a cancel cam, not illustrated, in accordance with rotating a steering wheel, not illustrated, in a state in which the operating lever 39 and the bracket 34 are disposed at a left turn indicating position or a right turn indicating position in turning operation.

According to the above-described embodiment, the following operation and effect can be achieved. That is, by constructing a constitution in which the insulator 32 is provided with the guide projected portion 46 for guiding to move the slider 45 for dimmer passing slid to move in the arrow mark B3 direction based on a pivoting operation of the operating lever 39 in the arrow mark B2 direction, and the case 33 is provided with the restricting portion 47 for restricting the slider 45 from moving to the upper side, a function of the guide portion provided at the middle case of the background art is distributed to the insulator 32 and the case 33. Thereby, the unit case 31 can be constituted by the insulator 32 and the case 33 having the ceiling portion 33a, and the middle case which has been needed in the background art can be abolished. Therefore, the number of parts can be reduced.

The invention is not only limited to the above-described embodiment but can be modified or expanded as follows.

The slider 65 can be constituted by a contact holder having a movable contact in place of the slider having the cam portion 69. In this case, a light switch as a switch element is constituted by a fixed contact provided at the upper surface of the insulator 32 and a movable contact brought into contact with and separated from the fixed contact in accordance with sliding to move the contact holder.

What is claimed is:

1. A vehicular lever switch apparatus comprising:
an insulator;
a case integrated to an upper portion of the insulator;
a slider slidably arranged at an upper surface of the insulator;
a slider guide portion including a cylindrical portion provided at the insulator for restricting the slider from moving in an upper direction and slidably guiding the slider;
a lever extended in an axial direction and provided to be able to be manipulated to pivot around the axial direction for sliding the slider in accordance with the pivoting manipulation of the lever; and
a switch element a state of which is switched in accordance with the sliding movement of the slider.

2. A vehicular lever switch apparatus comprising:
an insulator;
a case that includes a ceiling portion, is integrated to an upper portion of the insulator and constitutes a unit case in cooperation with the insulator;
an operating lever that includes an end portion inserted to inside of the unit case, a shaft portion which pivotably attached to the unit case as a fulcrum and the other end portion which is projected from the unit case to an outer side and is pivotably manipulated by a user;
a guide portion provided at an upper surface of the insulator;
a slider arranged at the upper surface of the insulator slidably along the guide portion and slid in accordance with pivoting movement of the one end portion of the operating lever based on a pivoting manipulation of the operating lever;
a restricting portion provided at the case for restricting the slider from moving in an upper direction; and
a switch element a state of which is switched in accordance with the sliding movement of the slider.
